(19) United States
(12) Patent Application Publication
(10) Pub. No.: US 2008/0107207 A1
(43) Pub. Date: May 8, 2008

(54) Broadcast receiving terminal

(76) Inventors: Shinji Nakamoto, Kanagawa (JP); Akira Harada, Kanagawa (JP); Masaharu Kudou, Kanagawa (JP); Kazuyuki Tanaka, Kanagawa (JP); Hiroaki Takeda, Kanagawa (JP)

Correspondence Address: MCDERMOTT WILL & EMERY LLP, 600 13TH STREET, NW, WASHINGTON, DC, 20005-3096, US

(21) Appl. No.: 11/976,665

(22) Filed: Oct. 26, 2007

(30) Foreign Application Priority Data
Nov. 6, 2006 (JP) P. 2006-300271
Aug. 7, 2007 (JP) P. 2007-205698

(51) Int. Cl. H04N 5/44; H04N 7/52

(52) U.S. Cl. 375/316; 375/240.26; 375/E07.271; 348/E05.108; 348/E05.101

(57) ABSTRACT

A broadcast receiving terminal is equipped with a receiving unit for receiving a broadcast signal; a separating unit for separating audio coded data and band expansion information from the broadcast signal received by the receiving unit; a low frequency band audio decoding unit for decoding the audio coded data so as to output low frequency band audio data; a high frequency band audio producing unit for producing high frequency band audio data by employing the band expansion information and the low frequency band audio data; a switching unit for switching a sound reproducing mode of the broadcast receiving terminal between a first mode for reproducing sound based upon both the low frequency band audio data and the high frequency band audio data, and a second mode for reproducing sound based upon only the low frequency band audio data; and a control unit for controlling the switching unit so as to constitute a mode selected in response to a predetermined condition.

### BACKGROUND OF THE INVENTION

1. Field of the Invention

The present invention is related to a broadcast receiving terminal capable of selectively performing a specific process operation requiring large power consumption in response to a condition thereof.

2. Description of the Related Art

As one of the Japanese ground-based digital television broadcasting services (ISDB-T), there is a so-called “1seg (trademark)” service which is provided for portable telephones and mobile terminals. The frequency band having approximately 6 MHz allocated to the Japanese ground-based digital television broadcasting system has been divided into 13 segments. In the “1seg” service, only 1 central segment (approximately, 429 KHz) within these 13 segments has been utilized.

FIG. 6 is a block diagram for representing a broadcast receiving terminal operable of receiving television broadcast programs produced in accordance with the so-called “1seg” service. As shown in FIG. 6, the broadcast receiving terminal is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, and a display 121.

The antenna 101 receives digital broadcast electromagnetic waves. The receiving unit 103 processes the digital broadcast electromagnetic waves received by the antenna 101 so as to output a transport stream signal (TS). The multiplexing/separating unit 105 separates the transport stream signal into an audio elementary stream signal (AUDIO ES) and a video elementary stream signal (VIDEO ES), and then, inputs the audio elementary stream signal to the band expansion information separating unit 107, and also, inputs the video elementary stream signal to the H.264 decoding unit 117.

The audio elementary stream signal corresponds to such a data compressed by an audio compression system called as “MPEG2 AAC+SBR”, the audio elementary stream signal data contains both audio coded data and band expansion information. The audio coded data corresponds to such a data compressed by an audio compression system called as AAC (Advanced Audio Coding). It should be understood that if audio data is compressed based upon the ACC system, then data of a high frequency component is deleted, and therefore, even when the ACC-compressed audio coded data is decoded, the high frequency band is not reproduced. The band expansion information corresponds to SBR (Spectral Band Replication: registered trademark) data which has compressed information indicative of a relative relationship between data of a low frequency component and a high frequency component which disappears when audio data is ACC-compressed.

The band expansion information separating unit 107 separates the audio elementary stream signal into audio coded signal and band expansion information, and then, inputs the audio coded data to the AAC decoding unit 109, and also, inputs the band expansion information to the SBR processing unit 111. The AAC decoding unit 109 decodes the audio coded data so as to output low frequency band audio data (processing operation by AAC decoding unit 109 will be referred to as “AAC processing operation” hereinafter). The SBR processing unit 111 predicts a high frequency audio band based upon the band expansion information and the low frequency band audio data so as to produce high frequency band audio data (processing operation by SBR processing unit 111 will be referred to as “SBR processing operation” hereinafter). The D/A converting unit 113 D/A converts the low frequency band audio data, and the high frequency band audio data. The speaker 115 outputs sound based upon the D/A-converted analog audio signal.

The video elementary stream signal corresponds to a stream compressed by the moving picture compressing system called as “H.264.” The H.264 decoding unit 117 decodes the video elementary stream signal so as to output video data. The display processing unit 119 performs such a processing operation for displaying the video data on the display 121. The display 121 displays thereon television pictures.

Patent Publication 1: JP-A-2004-53940

In accordance with the above-explained broadcast receiving terminal, since the high frequency band is also reproduced by the SBR processing operation, users can view television broadcast programs by hearing sound which is fidelity to original sound (namely, sound approximated to original sound source). It should be noted that since there are relatively large process amounts of SBR processing operation, power consumption required in the SBR processing unit 111 is large. When a power supply of the broadcast receiving terminal is a battery, it is desirable that the power consumption thereof is low in view of driving time.

### SUMMARY OF THE INVENTION

An object of the present invention is to provide a broadcast receiving terminal capable of selectively performing a specific processing operation requiring large power consumption in response to conditions thereof.

The present invention is to provide a broadcast receiving terminal featured by such a broadcast receiving terminal equipped with: a receiving unit for receiving a broadcast signal; a separating unit for separating audio coded data and band expansion information from the broadcast signal received by the receiving unit; a low frequency band audio decoding unit for decoding the audio coded data so as to output low frequency band audio data; a high frequency band audio producing unit for producing high frequency band audio data by employing the band expansion information and said low frequency band audio data; a switching unit for switching a sound reproducing mode of the broadcast receiving terminal between a first mode for reproducing sound based upon both the low frequency band audio data and the high frequency band audio data, and a second mode for reproducing sound based upon only the low frequency band audio data; and a control unit for controlling the switching unit to so as to constitute a mode selected in response to a predetermined condition.

The above-described broadcast receiving terminal is further comprised of: an operation unit through which a user of the broadcast receiving terminal operates the broadcast receiving terminal; and the control unit controls the switching unit so as to constitute the mode which is selected by the user by employing the operation unit.

The above-described broadcast receiving terminal is further comprised of: a battery for supplying electric power to the broadcast receiving terminal; a battery remaining power amount judging unit for judging a remaining power amount of the battery; and a comparing unit for comparing the remaining power amount of the battery with a threshold value; and the control unit controls the switching unit so as to constitute the mode which is selected in response to a comparison result made by the comparing unit.

In the above-described broadcast receiving terminal, when the remaining power amount judged by the battery remaining power amount judging unit is smaller than the threshold value, the control unit selects the second mode.

In the above-described broadcast receiving terminal, when the remaining power amount judged by the battery remaining power amount judging unit is larger than the threshold value, the control unit selects the first mode.

The above-described broadcast receiving terminal is further comprised of: a present time instant acquiring unit for acquiring a present time instant; a storage unit for storing thereinto a time instant range for setting the broadcast receiving terminal to any one of the first and second modes; and a comparing unit for comparing the present time instant with the time instant range; and the control unit controls the switching unit so as to constitute the mode which is selected in response to such a condition for indicating whether or not the present time instant is present within the time instant range.

In the above-described broadcast receiving terminal, when the present time instant is present within the time instant range, the control unit selects the second mode, whereas when the present time instant is present outside the time instant range, the control unit selects the first mode.

The above-described broadcast receiving terminal is further comprised of: a sound volume judging unit for judging a sound volume of the sound output; and a comparing unit for comparing the sound volume with a threshold value; and the control unit controls the switching unit so as to constitute the mode which is selected in response to a comparison result made by the comparing unit.

In the above-described broadcast receiving terminal, when the sound volume judged by the sound volume judging unit becomes smaller than the threshold value, the control unit selects the second mode.

In the above-described broadcast receiving terminal, when the sound volume judged by the sound volume judging unit becomes larger than the threshold value, the control unit selects the first mode.

The above-described broadcast receiving terminal is further comprised of: a sound output terminal into which an earphone is inserted and from which the earphone is extracted; and a terminal status judging unit for judging whether or not the earphone has been inserted into the sound output terminal; and the control unit controls the switching unit so as to constitute the mode which is selected in response to such a condition for indicating whether or not the earphone has been inserted into the sound output terminal.

In the above-described broadcast receiving terminal, when the earphone has been inserted into the sound output terminal, the control unit selects the first mode, whereas when the earphone has not been inserted into the sound output terminal, the control unit selects the second mode.

The above-described broadcast receiving terminal is further comprised of: a sound data producing unit for digitally processing sound entered to a microphone so as to produce digital sound data; an ambient noise predicting unit for predicting an ambient noise level based upon the digital sound data produced by the sound data producing unit; and an ambient noise comparing unit for comparing the ambient noise level with a threshold level; and the control unit controls the switching unit so as to constitute the mode which is selected in response to a comparison result made by the ambient noise comparing unit.

In the above-described broadcast receiving terminal, when the ambient noise level predicted by the ambient noise predicting unit becomes lower than the threshold level, the control unit selects the first mode.

In the above-described broadcast receiving terminal, when the ambient noise level predicted by the ambient noise predicting unit becomes higher than the threshold level, the control unit selects the second mode.

The above-described broadcast receiving terminal is further comprised of: a program information storage unit for previously storing thereinto program information indicative of a content of a program; a storage unit for storing thereinto a program sort list for setting the broadcast receiving terminal to any one of the first and second modes; a program sort judging unit for judging a program sort under reception based upon the program information of the program information storage unit; and a program sort comparing unit for performing a comparing operation for checking whether or not the program sort judged by the program sort judging unit is present in the program sort list; and the control unit controls the switching unit so as to constitute the mode which is selected in response to a comparison result made by the program sort comparing unit.

In the above-described broadcast receiving terminal, when the program sort judged by the program sort judging unit is contained in the program sort list, the control unit selects the second mode, whereas when the program sort judged by the program sort judging unit is not contained in the program sort list, the control unit selects the first mode.

The above-described broadcast receiving terminal is further comprised of: a present position acquiring unit for acquiring a present position of the broadcast receiving terminal; a storage unit for storing thereinto a positional range for setting the broadcast receiving terminal to any one of the first and second modes; and a present position judging unit for comparing the present position acquired by the present position acquiring unit with the positional range so as to judge that the present position of the broadcast receiving terminal is located in the vicinity of the positional range; and the control unit controls the switching unit so as to constitute the mode which is selected in response to a comparison result made by the present position judging unit.

In the above-described broadcast receiving terminal, when the broadcast receiving terminal is present within the position range, which is judged by the present position judging unit, the control unit selects the second mode.

In the above-described broadcast receiving terminal, when the broadcast receiving terminal is not present within the position range, which is judged by the present position judging unit, the control unit selects the first mode.

The above-described broadcast receiving terminal is further comprised of: a present position acquiring unit for acquiring a present position of the broadcast receiving terminal; a present position history storage unit for storing thereinto the present positions acquired by the present position acquiring unit by being dated back to a constant time; and a move judging unit for judging whether the broadcast receiving terminal is moved, or is stationary based upon a history as to the positional information of the broadcast receiving terminal obtained from the present position history storage unit; and the control unit controls the switching unit so as to constitute the mode which is selected in response to a judgement result of the move judging unit.

In the above-described broadcast receiving terminal, when the move judging unit judges that the broadcast receiving terminal has not been stationary for a constant time, the control unit selects the second mode.

In the above-described broadcast receiving terminal, when the move judging unit judges that the broadcast receiving terminal has not been moved for a constant time, the control unit selects the first mode.

The above-described broadcast receiving terminal is further comprised of: a battery for supplying electric power to the broadcast receiving terminal; and a battery under recharging operation judging unit for judging whether or not the battery is under recharging operation; and the control unit controls the switching unit so as to constitute the mode which is selected in response to such a condition for indicating whether or not the battery is under the recharging operation.

In the above-described broadcast receiving terminal, when the battery under recharging operation judging unit judges that the battery is not under the recharging operation, the control unit selects the second mode, whereas when the battery under recharging operation judging unit judges that the battery is under the recharging operation, the control unit selects the first mode.

The above-described broadcast receiving terminal is further comprised of: a display unit for displaying thereon information in the form of any one of a character and a figure; and in the case that the switching unit has switched the mode, the control unit performs a process operation in such a manner that the display unit displays thereon an indication for indicating that the mode has been switched.

In accordance with the broadcast receiving terminal related to the present invention, the execution of the specific processing operation requiring the large power consumption can be selectively switched in response to the conditions thereof.

### BRIEF DESCRIPTION OF THE DRAWINGS

FIG. 1 is a block diagram for showing a broadcast receiving terminal of a first embodiment mode.

FIG. 2 is a block diagram for indicating a broadcast receiving terminal of a second embodiment mode.

FIG. 3 is a block diagram for representing a broadcast receiving terminal of a third embodiment mode.

FIG. 4 is a block diagram for showing a broadcast receiving terminal of a fourth embodiment mode.

FIG. 5 is a block diagram for indicating a broadcast receiving terminal of a fifth embodiment mode.

FIG. 6 is a block diagram for representing a broadcast receiving terminal of a sixth embodiment mode.

FIG. 7 is a block diagram for showing a broadcast receiving terminal of a seventh embodiment mode.

FIG. 8 is a block diagram for indicating a broadcast receiving terminal of an eighth embodiment mode.

FIG. 9 is a block diagram for representing a broadcast receiving terminal of a ninth embodiment mode.

FIG. 10 is a block diagram for showing a broadcast receiving terminal of a tenth embodiment mode.

FIG. 11 is a block diagram for indicating the broadcast receiving terminal capable of receiving the television broadcast program based upon the “1seg” service.

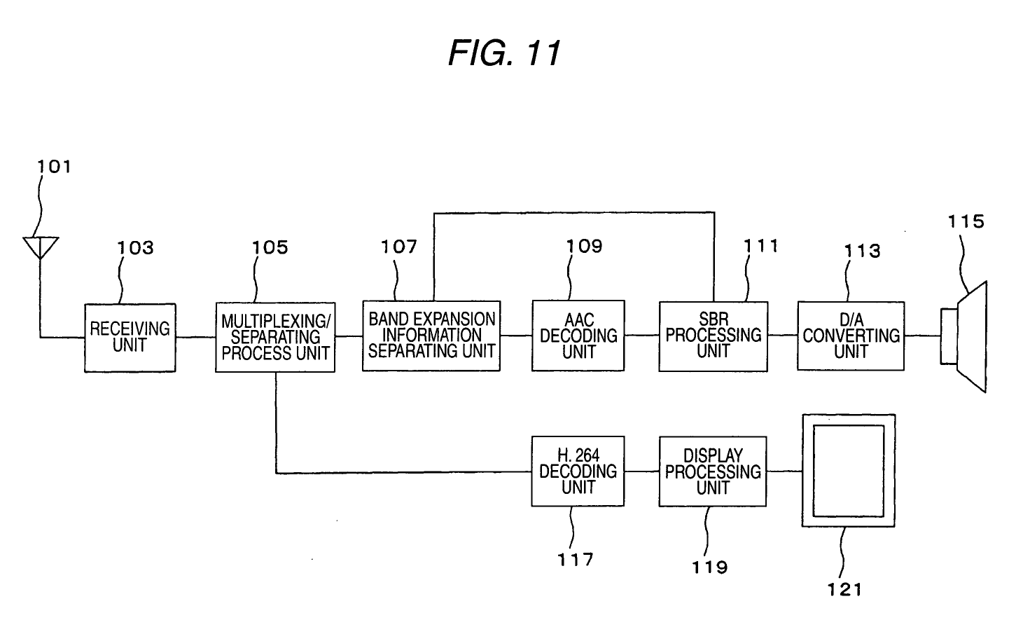

### DESCRIPTION OF THE PREFERRED EMBODIMENTS

Referring now to drawings, a description is made of embodiment modes of the present invention. Broadcast receiving terminals of the below-mentioned embodiment modes can be operated by receiving television broadcast programs produced based upon the above-explained “1seg” service.

### First Embodiment Mode

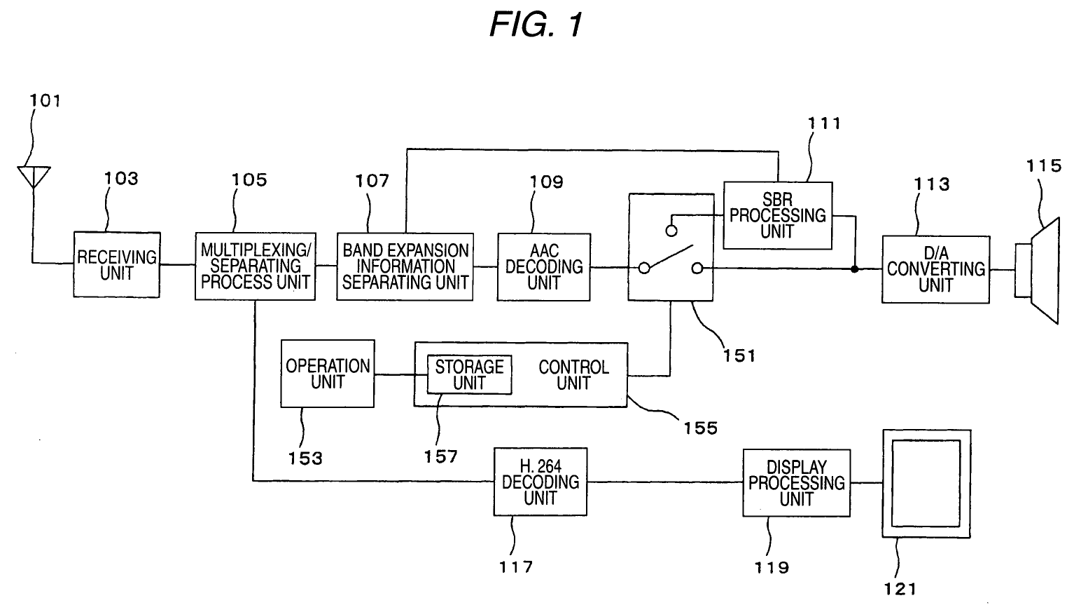

FIG. 1 is a block diagram for indicating a broadcast receiving terminal of a first embodiment mode. As shown in FIG. 1, the broadcast receiving terminal of the first embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, and a control unit 155. It should be noted that the multiplexing/separating process unit 105, the band expansion information separating unit 107, the AAC decoding unit 109, the SBR processing unit 111, the D/A converting unit 113, the H.264 decoding unit 117, the display processing unit 119, the switching unit 151, and the control unit 155 may be alternatively realized by a calculating process apparatus such as a CPU which is operated by executing a program.

The antenna 101 receives digital broadcast electromagnetic waves. The receiving unit 103 processes the digital broadcast electromagnetic waves received by the antenna 101 so as to output a transport stream signal (TS). The multiplexing/separating unit 105 separates the transport stream signal into an audio elementary stream signal (AUDIO ES) and a video elementary stream signal (VIDEO ES), and then, inputs the audio elementary stream signal to the band expansion information separating unit 107, and also, inputs the video elementary stream signal to the H.264 decoding unit 117.

The audio elementary stream signal corresponds to such a data compressed by an audio compression system called as “MPEG2 AAC+SBR”, and the audio elementary stream signal data contains both audio coded data and band expansion information. The audio coded data corresponds to such a data compressed by an audio compression system called as AAC (Advanced Audio Coding). It should also be understood that if audio data is compressed based upon the ACC system, then data of a high frequency component is deleted, and therefore, even when the ACC-compressed audio coded data is decoded, the high frequency band is not reproduced. The band expansion information corresponds to SBR (Spectral Band Replication: registered trademark) data which has compressed information indicative of a relative relationship between data of a low frequency component and a high frequency component which disappears when audio data is ACC-compressed.

The band expansion information separating unit 107 separates the audio elementary stream signal into audio coded signal and band expansion information, and then, inputs the audio coded data to the AAC decoding unit 109, and also, inputs the band expansion information to the SBR processing unit 111. The AAC decoding unit 109 decodes the audio coded data so as to output low frequency band audio data (processing operation by AAC decoding unit 109 will be referred to as “AAC processing operation” hereinafter). The SBR processing unit 111 predicts a high frequency audio band based upon the band expansion information and the low frequency band audio data so as to produce high frequency band audio data (processing operation by SBR processing unit 111 will be referred to as “SBR processing operation” hereinafter). The D/A converting unit 113 D/A converts the audio data. The speaker 115 outputs sound based upon the D/A-converted analog audio signal.

The video elementary stream signal corresponds to a stream compressed by the moving picture compressing system called as “H.264.” The H.264 decoding unit 117 decodes the video elementary stream signal so as to output video data. The display processing unit 119 performs such a processing operation for displaying the video data on the display 121. The display 121 displays thereon television pictures.

In the first embodiment mode, as audio reproducing modes of the broadcast receiving terminal, the below-mentioned two modes have been prepared; namely, in a normal mode, audio data produced based upon both low frequency band audio data and high frequency band audio data is reproduced; and in a power saving mode, audio data produced based upon only the low frequency band audio data is reproduced. The switching unit 151 switches the operation mode between the normal mode and the power saving mode in response to an instruction issued from the control unit 155. Under such a condition that the broadcast receiving terminal has been set to the normal mode, the low frequency band audio data outputted from the AAC decoding unit 109 is entered to the SBR processing unit 111. On the other hand, under such a condition that the broadcast receiving terminal has been set to the power saving mode, the low frequency band audio data outputted from the AAC decoding unit 109 is not entered to the SBR processing unit 111, but is entered to the D/A converting unit 113. As a result, the SBR process operation is not carried out when the power saving mode is selected.

When the broadcast receiving terminal has been set to the normal mode, the D/A converting unit 113 D/A-converts both the low frequency band audio data and high frequency band audio data. As a consequence, the speaker 115 outputs sound of the broad band. On the other hand, when the broadcast receiving terminal has been set to the power saving mode, since the high frequency band audio data is not inputted to the D/A converting unit 113, the D/A converting unit 113 D/A-converts the low frequency band audio data. As a consequence, the speaker 115 outputs sound excluding the higher tone range.

The operation unit 153 corresponds to an input interface via which a user operates the broadcast receiving terminal. The user can select either the normal mode or the power saving mode by employing the operation unit 153. The control unit 155 controls the respective structural elements in such a manner that the operation mode of the broadcast receiving terminal becomes a mode selected by operating the operation unit 153 by the user. While the control unit 155 contains a storage unit 157, the mode selected by the user is stored in this storage unit 157. Alternatively, the control unit 155 may perform a processing operation in such a manner that when the switching unit 151 has switched the sound reproducing mode, the display 121 displays such an indication message that the reproducing mode has been switched.

As previously described, in the first embodiment mode, as the sound reproducing mode of the broadcast receiving terminal, the user can switch either the normal mode or the power saving mode. There is a difference in percent articulation between the sound of the broad band, which is reproduced during the normal mode, and the sound excluding the higher tone range, which is reproduced during the power saving mode. Comparing with the sound of the broad band, the percent articulation of the sound containing no higher tone range is low, and is heard as sound with unclear feelings. However, since the SBR processing operation is not carried out during the power saving mode, the power consumption can be suppressed. As a result, since such a user who can accept a deterioration of a sound quality switches the operation mode to the power saving mode, this user can view television programs for a longer time than that when the normal mode is selected. Also, in the first embodiment mode, since a plurality of modes are prepared, the broadcast receiving terminal can meet such a user requirement that the television programs can be viewed for a long time.

### Second Embodiment Mode

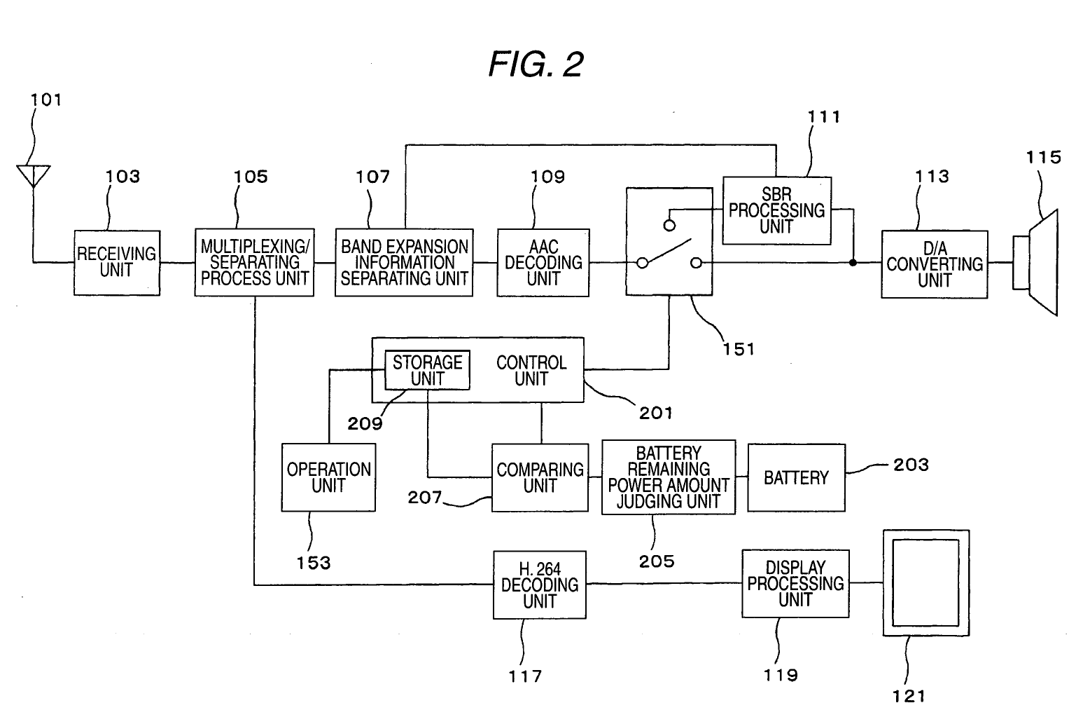

FIG. 2 is a block diagram for indicating a broadcast receiving terminal of a second embodiment mode. As shown in FIG. 2, the broadcast receiving terminal of the first embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, a control unit 201, a battery 203, a battery remaining power amount judging unit 205, and a comparing unit 207. It should be noted that the same reference numerals shown in FIG. 1 will be employed as those for denoting the commonly-used structural elements of FIG. 2, and therefore, descriptions thereof will be omitted in the second embodiment mode.

The battery 203 supplies electric power to the broadcast receiving terminal of the second embodiment mode. The battery remaining power amount judging unit 205 judges a remaining power amount of the battery 203. The comparing unit 207 compares a threshold value stored in a storage unit 209 contained in the control unit 201 with a remaining power amount judged by the battery remaining power amount judging unit 205. The control unit 201 selects either the normal mode or the power saving mode in response to a large-small relationship between the threshold value and the remaining power amount judged by the battery remaining power amount judging unit 205, and then controls the switching unit 151 so as to constitute the selected mode.

Concretely speaking, when a remaining power amount of the battery 203 becomes smaller than the threshold value under such a condition that the broadcast receiving terminal has been set to the normal mode, the control unit 201 controls the switching unit 151 so as to switch the normal mode into the power saving mode. Also, when a remaining power amount of the battery 203 becomes larger than the threshold value under such a condition that the broadcast receiving terminal has been set to the power saving mode, the control unit 201 controls the switching unit 151 so as to switch the power saving mode into the normal mode. It should also be noted that the storage unit 209 is a rewritable memory, and thus, the user of the broadcast receiving terminal may rewrite the above-described threshold value by operating the operation unit 153.

As previously described, in the second embodiment mode, the control unit 201 selects the sound reproducing mode in response to the remaining power amount of the battery 203. As a consequence, after the remaining power amount of the battery 203 becomes smaller than the threshold value, the power consumption of the broadcast receiving terminal can be suppressed, as compared with that of the normal condition. Also, in the second embodiment mode, the user of the broadcast receiving terminal is no longer required to perform such an operation for selecting the sound reproducing mode by confirming the remaining power amount of the battery 203.

### Third Embodiment Mode

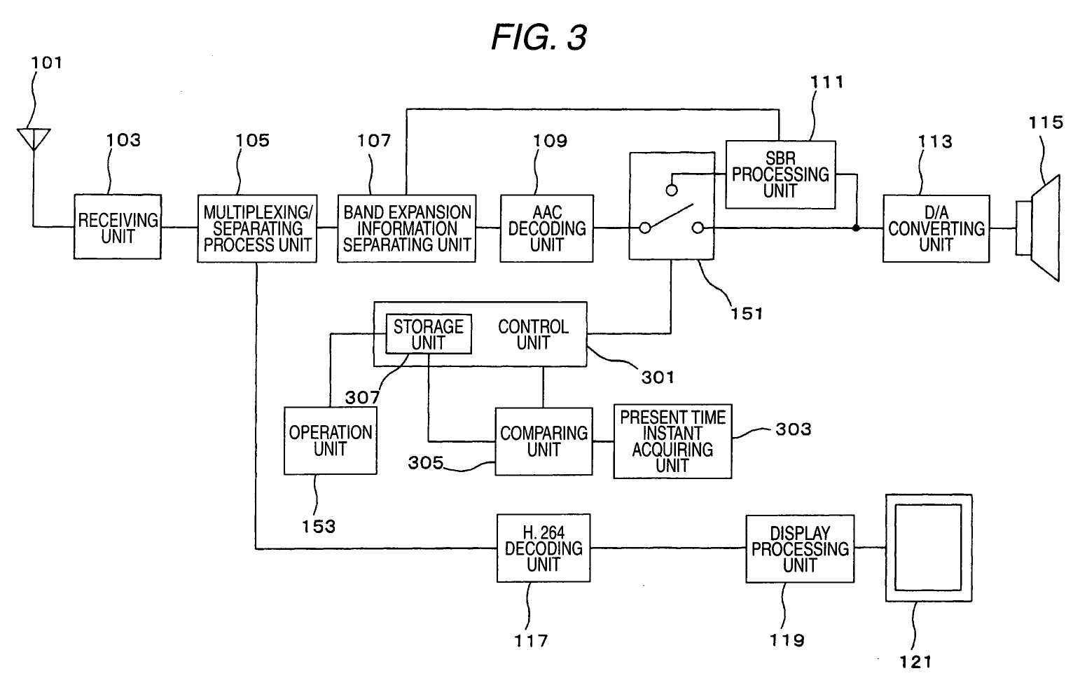

FIG. 3 is a block diagram for indicating a broadcast receiving terminal of a third embodiment mode. As shown in FIG. 3, the broadcast receiving terminal of the third embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 301, a present time instant acquiring unit 303, and a comparing unit 305. It should be noted that the same reference numerals shown in FIG. 1 will be employed as those for denoting the commonly-used structural elements of FIG. 3, and therefore, descriptions thereof will be omitted in the third embodiment mode.

The present time instant acquiring unit 303 acquires a present time instant from an internal clock (not shown) contained in the broadcast receiving terminal. The comparing unit 305 compares a time instant range with the present time instant acquired by the present time instant acquiring unit 303, while the time instant range is stored in a storage unit 307 contained in the control unit 301. The control unit 301 selects either the normal mode or the power saving mode in response to such a condition for indicating whether or not the present time instant is located with the time instant range, and thus, controls the switching unit 151 so as to constitute the selected mode. Concretely speaking, when the present time instant is located within the time instant range, the control unit 301 selects the power saving mode, whereas when the present time instant is located outside the time instant range, the control unit 301 selects the normal mode. It should also be noted that the storage unit 307 is a rewritable memory, and thus, the user of the broadcast receiving terminal may rewrite the above-described time instant range by operating the operation unit 153.

As previously described, in the third embodiment mode, the control unit 301 selects the sound reproducing mode in response to the time instant. As a consequence, in a predetermined time range, the power consumption of the broadcast receiving terminal can be suppressed, as compared with that of the normal mode. For instance, in such a case that although the user brings the broadcast receiving terminal in the daytime, the broadcast receiving terminal is put on a recharging base (not shown) so as to be electrically connected to the commercial power supply in the nighttime, if the time range of the daytime has been set to the above-described time instant range, then the power consumption caused by that the user views the broadcast program in the daytime can be suppressed. Also, in the third embodiment mode, the user of the broadcast receiving terminal is no longer required to perform such an operation for selecting the sound reproducing mode by confirming the present time instant.

### Fourth Embodiment Mode

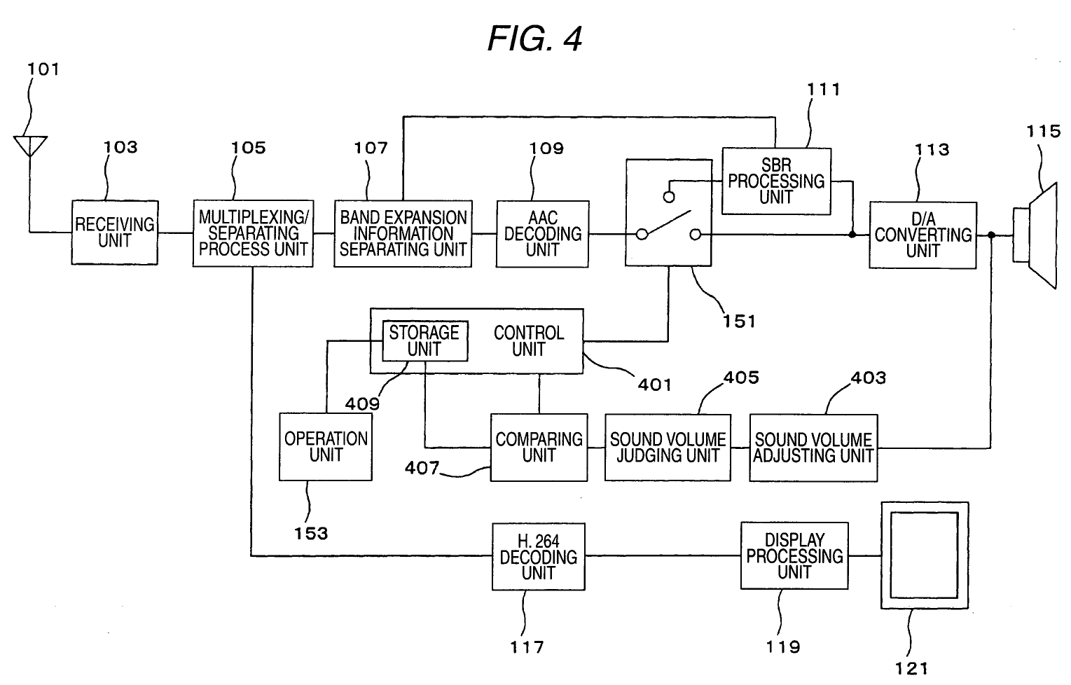

FIG. 4 is a block diagram for indicating a broadcast receiving terminal of a fourth embodiment mode. As shown in FIG. 4, the broadcast receiving terminal of the fourth embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 401, a sound volume adjusting unit 403, a sound volume judging unit 405, and a comparing unit 407. It should be noted that the same reference numerals shown in FIG. 1 will be employed as those for denoting the commonly-used structural elements of FIG. 4, and therefore, descriptions thereof will be omitted in the fourth embodiment mode.

The sound volume adjusting unit 403 adjusts a sound volume of sound outputted from the speaker 115. It should also be understood that although the sound volume adjusting unit 403 has been provided at the post stage of the D/A converting unit 113 in this fourth embodiment mode, the sound volume adjusting unit 403 may be alternatively provided at a front stage of the D/A converting unit 113 so as to perform a sound volume adjusting operation. The sound volume judging unit 405 judges that a sound volume has been set to which degree. The comparing unit 407 compares a threshold value stored in a storage unit 409 contained in the control unit 401 with the sound volume judged by the sound volume judging unit 405. The control unit 401 selects either the normal mode or the power saving mode in response to a large/small relationship between the threshold value and the sound volume judged by the sound volume judging unit 405, and then controls the switching unit 151 so as to constitute the selected mode. Concretely speaking, when the sound volume becomes smaller than the threshold value, the control unit 401 selects the power saving mode, whereas when the sound volume becomes larger than the threshold value, the control unit 401 selects the normal mode. It should also be noted that the storage unit 409 is a rewritable memory, and thus, the user of the broadcast receiving terminal may rewrite the above-described threshold value by operating the operation unit 153.

As previously described, in the fourth embodiment mode, the control unit 501 selects the sound reproducing mode in response to the sound volume. As a consequence, when the sound volume becomes smaller than the threshold value, the power consumption of the broadcast receiving terminal can be suppressed, as compared with that of the normal condition. In a degree of such a sound volume that the user cannot clearly hear sound, an influence caused by the percent articulation of the sound is small, so that the broadcast receiving terminal can be sufficiently operated even in the power saving mode. Also, in the fourth embodiment mode, the user of the broadcast receiving terminal is no longer required to perform such an operation for selecting the sound reproducing mode by confirming the sound volume.

### Fifth Embodiment Mode

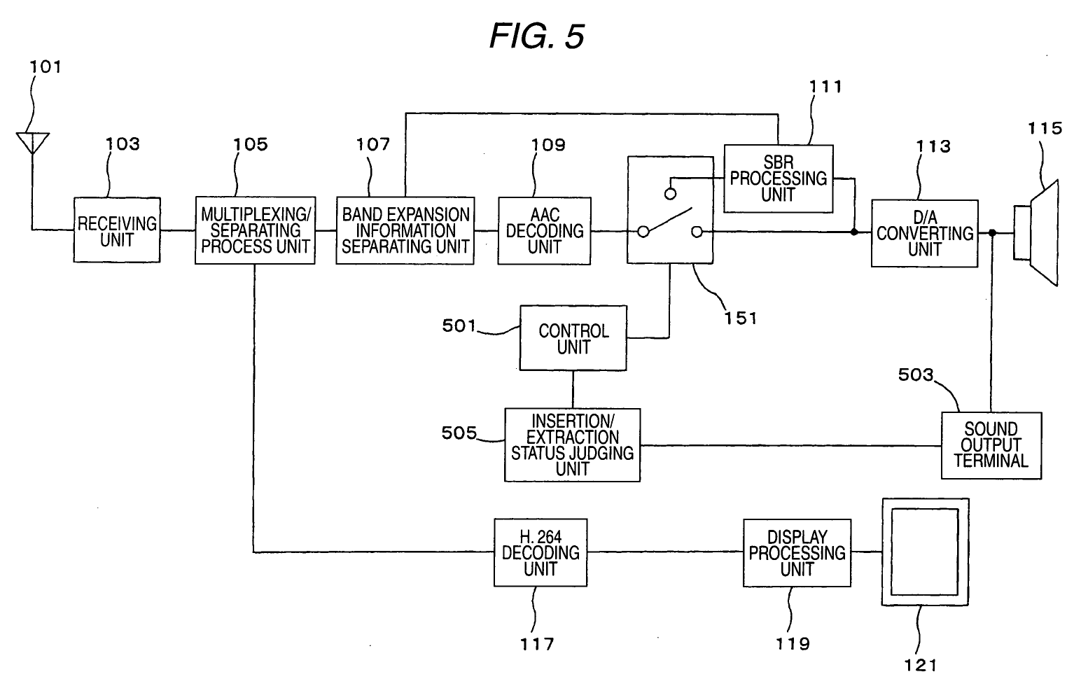

FIG. 5 is a block diagram for indicating a broadcast receiving terminal of a fifth embodiment mode. As shown in FIG. 5, the broadcast receiving terminal of the fifth embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, a control unit 501, a sound output terminal 503, and an insertion/extraction status judging unit 505. It should be noted that the same reference numerals shown in FIG. 1 will be employed as those for denoting the commonly-used structural elements of FIG. 5, and therefore, descriptions thereof will be omitted in the fifth embodiment mode.

The sound output terminal 503 is such a terminal employed in order to insert thereinto a plug of a headphone, an earphone, and the like. The sound output terminal 503 outputs an analog audio signal D/A-converted by the D/A converting unit 113. It should also be noted that under such a condition that the plug has been inserted in the sound output terminal 503, the speaker 115 does not output sound. The insertion/extraction judging unit 505 judges whether or not the plug has been inserted in the sound output terminal 503. The control unit 501 selects either the normal mode or the power saving mode in response to such a condition for indicating whether or not the plug has been inserted in the sound output terminal 503, and controls the switching unit 151 so as to constitute the selected mode. Concretely speaking, in such a condition that the plug has been inserted in the sound output terminal 503, the control unit 501 selects the normal mode, whereas in such a condition that the plug has not been inserted in the sound output terminal 503, the control unit 501 selects the power saving mode.

As previously described, in this fifth embodiment mode, the control unit 501 selects the sound reproducing mode in response to such a condition for indicating whether or not the plug has been inserted in the sound output terminal 503. The power consumption occurred under such a condition that the plug has been inserted in the sound output terminal 503 is lower than the power consumption occurred when the sound is outputted from the speaker 115. As a consequence, the power consumption when the sound is outputted from the speaker 115 can be suppressed. Also, in this fifth embodiment mode, every time the plug is inserted and extracted into and from the sound output terminal 503, the user of the broadcast receiving terminal is no longer required to perform such an operation of selecting the sound reproducing mode.

### Sixth Embodiment Mode

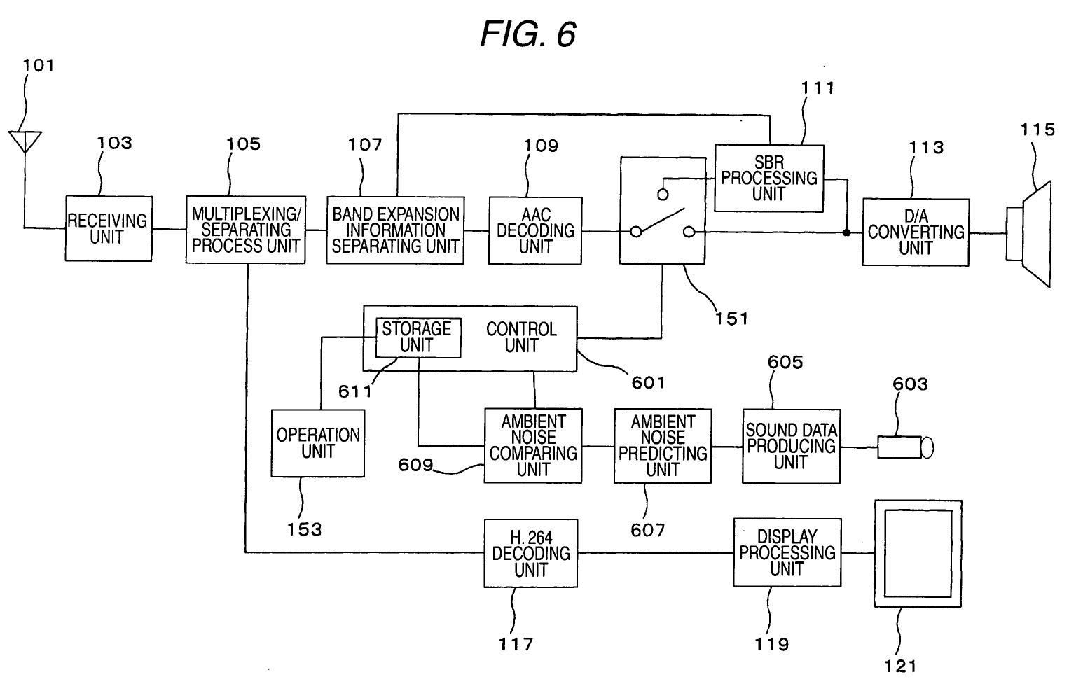

FIG. 6 is a block diagram for indicating a broadcast receiving terminal of a sixth embodiment mode. As shown in FIG. 6, the broadcast receiving terminal of the sixth embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 601, a microphone 603, a sound data producing unit 605, an ambient noise predicting unit 607, an ambient noise comparing unit 609, and a storage unit 611. It should be noted that the same reference numerals shown in FIG. 1 will be employed as those for denoting the commonly-used structural elements of FIG. 6, and therefore, descriptions thereof will be omitted in the sixth embodiment mode.

The microphone 603 collects ambient noise and then converts the collected ambient noise into an electric signal. The sound data producing unit 605 converts the ambient noise collected by the microphone 603 into digital data. The ambient noise predicting unit 607 predicts an ambient noise level by processing the digital data obtained by the sound data producing unit 605. The ambient noise comparing unit 609 compares the ambient noise level predicted by the ambient noise predicting unit 607 with a threshold level stored in the storage unit 611 contained in the control unit 601. The control unit 601 selects either the normal mode or the power saving mode in response to a large/small relationship between the threshold value and the ambient noise level predicted by the ambient noise predicting unit 607, and then controls the switching unit 151 so as to constitute the selected mode. Concretely speaking, when the predicted ambient noise level becomes higher than the threshold level, the control unit 601 selects the power saving mode, whereas when the predicted ambient noise level becomes lower than the threshold level, the control unit 601 selects the normal mode. It should also be noted that the storage unit 611 is a rewritable memory, and thus, the user of the broadcast receiving terminal may rewrite the above-described threshold value by operating the operation unit 153.

As previously described, in the sixth embodiment mode, the control unit 601 selects the sound reproducing mode in response to the predicted ambient noise level. As a consequence, when the predicted ambient noise is higher than the threshold level, the power consumption of the broadcast receiving terminal can be suppressed, as compared with that of the normal mode. Since the influence caused by the percent articulation of the sound is small under such a condition that the ambient noise level is high and thus the user can hardly listen to the sound clearly, the broadcast receiving terminal can be sufficiently operated even in the power saving mode. Also, in the sixth embodiment mode, the user of the broadcast receiving terminal is no longer required to perform such an operation for selecting the sound reproducing mode in response to the ambient conditions.

### Seventh Embodiment Mode

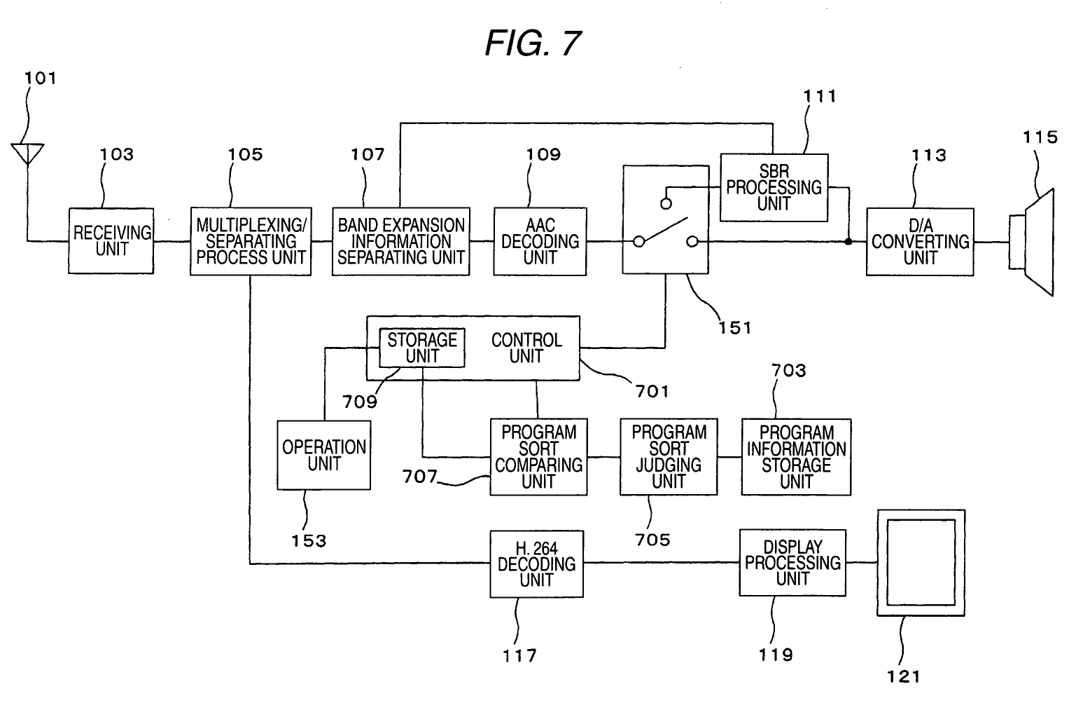

FIG. 7 is a block diagram for indicating a broadcast receiving terminal of a seventh embodiment mode. As shown in FIG. 7, the broadcast receiving terminal of the seventh embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 701, a program information storage unit 703, a program sort judging unit 705, a program sort comparing unit 707, and a storage unit 709. It should be noted that the same reference numerals shown in FIG. 1 will be employed as those for denoting the commonly-used structural elements of FIG. 7, and therefore, descriptions thereof will be omitted in the seventh embodiment mode.

The program information storage unit 703 has stored thereinto program information under viewing operation. The program sort judging unit 705 judges a sort of a program based upon the program information stored in the program information storage unit 703. The program sort comparing unit 707 performs such a comparing operation for checking whether or not the program sort judged by the program information judging unit 705 is present in a program sort list stored in the storage unit 709 contained by the control unit 701. The control unit 701 selects either the normal mode or the power saving mode in response to the comparison result made by the comparing unit 707, and then controls the switching unit 151 so as to constitute the selected mode. Concretely speaking, when the program sort under viewing operation is present in the program sort list stored in the storage unit 709, the control unit 701 selects the power saving mode, whereas when the program sort under viewing operation is not present in the program sort list stored in the storage unit 709, the control unit 701 selects the normal mode. It should also be noted that the storage unit 709 is a rewritable memory, and thus, the user of the broadcast receiving terminal may rewrite the above-described program sort list by operating the operation unit 153.

As previously described, in the seventh embodiment mode, the control unit 701 selects the sound reproducing mode in response to the program sort underviewing operation. As a consequence, in such a case that a sports program and a news program superimposed with subtitles have been registered in the program sort list, when the user views these programs, the power consumption of the broadcast receiving terminal can be suppressed, as compared with that of the normal mode. Since the influence caused by the percent articulation of the sound such as the sports program and the news program superimposed with the subtitles is small, the broadcast receiving terminal can be operated even in the power saving mode. Also, in this seventh embodiment mode, the user of the broadcast receiving terminal is no longer required to perform such an operation for selecting the sound reproducing mode in response to the program sort to be viewed.

### Eighth Embodiment Mode

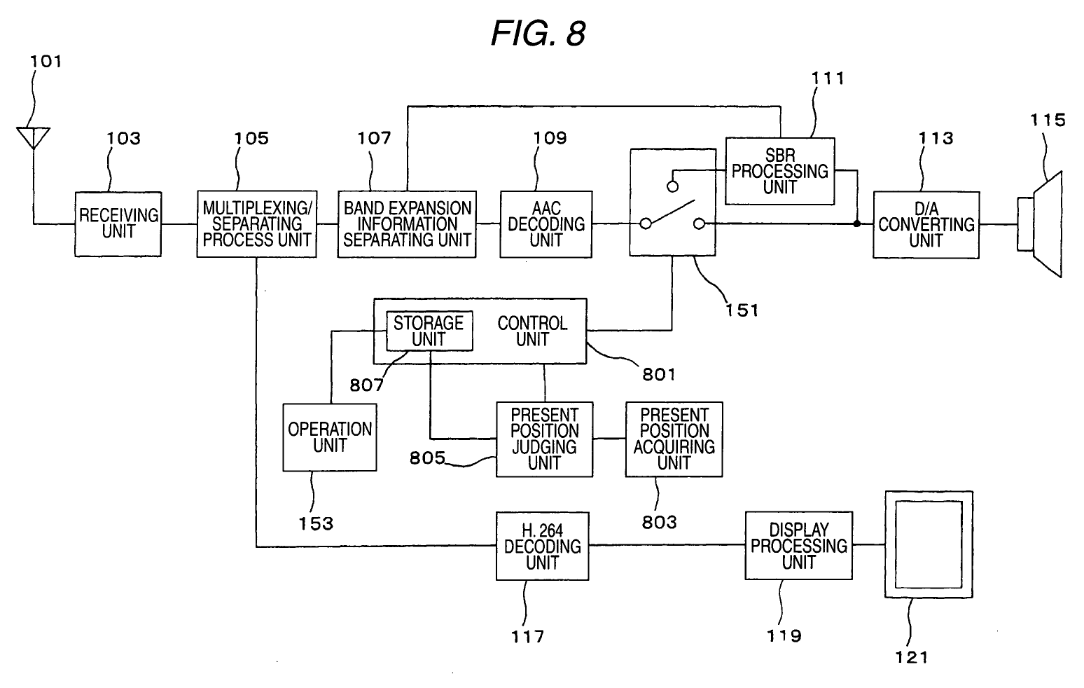

FIG. 8 is a block diagram for indicating a broadcast receiving terminal of an eighth embodiment mode. As shown in FIG. 8, the broadcast receiving terminal of the eighth embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 801, a present position acquiring unit 803, a present position judging unit 805, and a storage unit 807. It should be noted that the same reference numerals shown in FIG. 1 will be employed as those for denoting the commonly-used structural elements of FIG. 8, and therefore, descriptions thereof will be omitted in the eighth embodiment mode.

The present position acquiring unit 803 acquires a present position from a GPS (Global Positioning System) receiving apparatus, or the like. The present position judging unit 805 judges whether or not a positional range stored in the storage unit 807 employed in the control unit 801 is located in the vicinity of the present position acquired from the present position acquiring unit 803. The control unit 801 selects either the normal mode or the power saving mode in response to the judgement result made by the present position judging unit 805, and then controls the switching unit 151 so as to constitute the selected mode. Concretely speaking, when the present position of the broadcast receiving terminal is located in the vicinity of the positional range stored in the storage unit 807, the control unit 801 selects the power saving mode, whereas when the present position of the broadcast receiving terminal is not located in the vicinity of the positional range stored in the storage unit 807, the control unit 801 selects the normal mode. It should also be noted that the storage unit 807 is a rewritable memory, and thus, the user of the broadcast receiving terminal may rewrite the above-described positional range by operating the operation unit 153.

As previously described in this eighth embodiment mode, the control unit 801 selects the sound reproducing mode in response to the present position of the broadcast receiving terminal. As a consequence, the power consumption of the broadcast receiving terminal can be suppressed at a predetermined place, as compared with that of the normal mode. For example, if such a place into which the user frequently enters is registered as the positional range, then the power consumption of the broadcast receiving terminal at a place where the user goes out can be suppressed. Also, in this eighth embodiment mode, the user of the broadcast receiving terminal is no longer required to perform such an operation for selecting the sound reproducing mode in response to the present position.

### Ninth Embodiment Mode

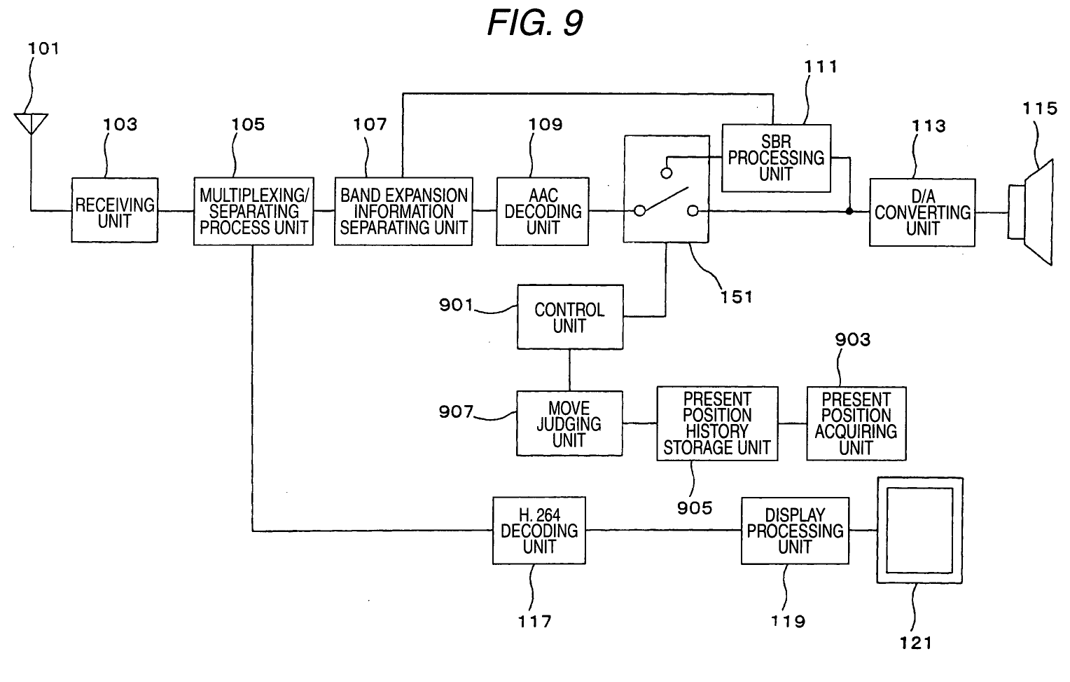

FIG. 9 is a block diagram for indicating a broadcast receiving terminal of a ninth embodiment mode. As shown in FIG. 9, the broadcast receiving terminal of the ninth embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 901, a present position acquiring unit 903, a present position history storage unit 905, and a move judging unit 907. It should be noted that the same reference numerals shown in FIG. 1 will be employed as those for denoting the commonly-used structural elements of FIG. 9, and therefore, descriptions thereof will be omitted in the ninth embodiment mode.

The present position acquiring unit 903 acquires a present position from a GPS (Global Positioning System) receiving apparatus, or the like. The present position history storage unit 905 stores thereinto present positions acquired by the present position acquiring unit 903 in a predetermined interval for a constant time period. The move judging unit 907 judges whether the broadcast receiving terminal is moved, or is stationary based upon the history as to the present positions acquired from the present position history storage unit 905. The control unit 901 selects either the normal mode or the power saving mode in response to the judgement result made by the move judging unit 907, and then controls the switching unit 151 so as to constitute the selected mode. Concretely speaking, when the move judging unit 907 judges that the broadcast receiving terminal is moved, the control unit 901 selects the power saving mode, whereas when the move judging unit 907 judges that the broadcast receiving terminal is stationary, the control unit 901 selects the normal mode.

As previously described in this ninth embodiment mode, the control unit 901 selects the sound reproducing mode in response to such a condition that the broadcast receiving terminal is stationary, or is moved. As a consequence, the power consumption of the broadcast receiving terminal can be suppressed in such a case that the broadcast receiving terminal is moved, as compared with that of the normal mode. For instance, the power consumption of the broadcast receiving terminal can be suppressed at a place where the user goes out, e.g., in a train. Also, in this eighth embodiment mode, the user of the broadcast receiving terminal is no longer required to perform such an operation for selecting the sound reproducing mode in response to such a condition that the user of the broadcast receiving terminal is moving.

### Tenth Embodiment Mode

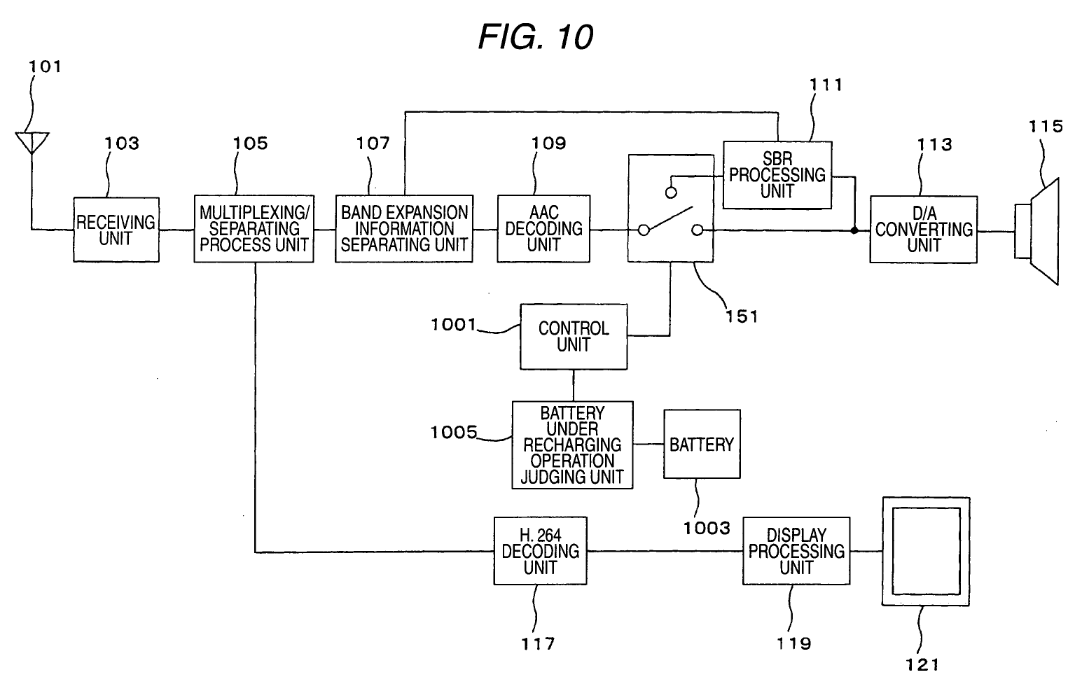

FIG. 10 is a block diagram for indicating a broadcast receiving terminal of a tenth embodiment mode. As shown in FIG. 10, the broadcast receiving terminal of the tenth embodiment mode is equipped with an antenna 101, a receiving unit 103, a multiplexing/separating process unit 105, a band expansion information separating unit 107, an AAC decoding unit 109, an SBR processing unit 111, a D/A converting unit 113, a speaker 115, an H.264 decoding unit 117, a display processing unit 119, a display 121, a switching unit 151, an operation unit 153, a control unit 1001, a battery 1003, and a battery under recharging operation judging unit 1005. It should be noted that the same reference numerals shown in FIG. 1 will be employed as those for denoting the commonly-used structural elements of FIG. 10, and therefore, descriptions thereof will be omitted in the tenth embodiment mode.

The battery 1003 supplies electric power to the broadcast receiving terminal of this tenth embodiment mode. The battery under recharging operation judging unit 1005 judges whether or not the battery 1003 is under recharging operation. The control unit 1001 selects either the normal mode or the power saving mode in response to the judgement result made by the battery under recharging operation judging unit 1005, and then controls the switching unit 151 so as to constitute the selected mode. Concretely speaking, when the battery under recharging operation judging unit 1005 judges that the battery 1003 is not under the recharging operation, the control unit 1001 selects the power saving mode, whereas when the battery under recharging operation judging unit 1005 judges that the battery 1003 is under the recharging operation, the control unit 1001 selects the normal mode.

As previously described in this tenth embodiment mode, the control unit 1001 selects the sound reproducing mode in response to such a condition for indicating whether or not the broadcast receiving terminal is under the recharging operation. As a consequence, the power consumption of the broadcast receiving terminal can be suppressed, as compared with that of the normal mode, in the case that the broadcast receiving terminal is not under the recharging operation. For instance, the power consumption can be suppressed under such a circumstance that the broadcast receiving terminal cannot be recharged at a place where the user goes out. Also, in this tenth embodiment mode, the user of the broadcast receiving terminal is no longer required to perform such an operation for selecting the sound reproducing mode in response to such a condition for indicating whether or not the broadcast receiving terminal is under the recharging operation.

It should also be understood that in the first to tenth embodiment modes, the broadcast receiving terminals capable of receiving the “1seg” service of the ground-based digital television system have been exemplified. Alternatively, such a broadcast receiving terminal capable of receiving a digital radio program may be employed. Also, the first embodiment mode has described that when the switching unit 151 has switched the sound reproducing mode, the control unit 155 may alternatively perform the processing operation in such a manner that the display 121 displays thereon such an indication message that the operation mode has been switched. This processing operation may be similarly applied to the second to tenth embodiment modes.

The broadcast receiving terminal related to the present invention can selectively select the execution of the specific processing operation requiring the large power consumption, and is useful as a terminal capable of receiving a broadcast program.

What is claimed is:

1. A broadcast receiving terminal, comprising:
a receiving unit for receiving a broadcast signal;
a separating unit for separating audio coded data and band expansion information from the broadcast signal received by said receiving unit;
a low frequency band audio decoding unit for decoding said audio coded data so as to output low frequency band audio data;
a high frequency band audio producing unit for producing high frequency band audio data by employing said band expansion information and said low frequency band audio data;
a switching unit for switching a sound reproducing mode of said broadcast receiving terminal between a first mode for reproducing sound based upon both said low frequency band audio data and said high frequency band audio data, and a second mode for reproducing sound based upon only said low frequency band audio data; and
a control unit for controlling said switching unit so as to constitute a mode selected in response to a predetermined condition.

2. The broadcast receiving terminal as claimed in claim 1, further comprising:
an operation unit through which a user of said broadcast receiving terminal operates said broadcast receiving terminal; and wherein:
said control unit controls said switching unit so as to constitute the mode which is selected by the user by employing said operation unit.

3. The broadcast receiving terminal as claimed in claim 1, further comprising:
a battery for supplying electric power to said broadcast receiving terminal;
a battery remaining power amount judging unit for judging a remaining power amount of said battery; and
a comparing unit for comparing said remaining power amount of the battery with a threshold value; and wherein:
said control unit controls said switching unit so as to constitute the mode which is selected in response to a comparison result made by said comparing unit.

4. The broadcast receiving terminal as claimed in claim 3 wherein:
when the remaining power amount judged by said battery remaining power amount judging unit is smaller than said threshold value, said control unit selects the second mode.

5. The broadcast receiving terminal as claimed in claim 4 wherein:
when the remaining power amount judged by said battery remaining power amount judging unit is larger than said threshold value, said control unit selects the first mode.

6. The broadcast receiving terminal as claimed in claim 1 wherein:
said broadcast receiving terminal is further comprised of:
a present time instant acquiring unit for acquiring a present time instant;
a storage unit for storing thereinto a time instant range for setting said broadcast receiving terminal to any one of said first and second modes; and
a comparing unit for comparing said present time instant with said time instant range; and wherein:
said control unit controls said switching unit so as to constitute the mode which is selected in response to such a condition for indicating whether or not said present time instant is present within said time instant range.

7. The broadcast receiving terminal as claimed in claim 6 wherein:
when said present time instant is present within said time instant range, said control unit selects the second mode, whereas when said present time instant is present outside said time instant range, said control unit selects the first mode.

8. The broadcast receiving terminal as claimed in claim 1 wherein:
said broadcast receiving terminal is further comprised of:
a sound volume judging unit for judging a sound volume of said sound output; and
a comparing unit for comparing said sound volume with a threshold value; and wherein:
said control unit controls said switching unit so as to constitute the mode which is selected in response to a comparison result made by said comparing unit.

9. The broadcast receiving terminal as claimed in claim 8 wherein:
when the sound volume judged by said sound volume judging unit becomes smaller than said threshold value, said control unit selects said second mode.

10. The broadcast receiving terminal as claimed in claim 9 wherein:
when the sound volume judged by said sound volume judging unit becomes larger than said threshold value, said control unit selects said first mode.

11. The broadcast receiving terminal as claimed in claim 1, further comprising:
a sound output terminal into which an earphone is inserted and from which the earphone is extracted; and
a terminal status judging unit for judging whether or not said earphone has been inserted into said sound output terminal; and wherein:
said control unit controls the switching unit so as to constitute the mode which is selected in response to such a condition for indicating whether or not said earphone has been inserted into said sound output terminal.

12. The broadcast receiving terminal as claimed in claim 11 wherein:
when said earphone has been inserted into said sound output terminal, said control unit selects the first mode, whereas when said earphone has not been inserted into said sound output terminal, said control unit selects the second mode.

13. The broadcast receiving terminal as claimed in claim 1, further comprising:
a sound data producing unit for digitally processing sound entered to a microphone so as to produce digital sound data;
an ambient noise predicting unit for predicting an ambient noise level based upon the digital sound data produced by said sound data producing unit; and
an ambient noise comparing unit for comparing said ambient noise level with a threshold level; and wherein:
said control unit controls the switching unit so as to constitute the mode which is selected in response to a comparison result made by said ambient noise comparing unit.

14. The broadcast receiving terminal as claimed in claim 13 wherein:
when the ambient noise level predicted by said ambient noise predicting unit becomes lower than said threshold level, said control unit selects the first mode.

15. The broadcast receiving terminal as claimed in claim 13 wherein:
when the ambient noise level predicted by said ambient noise predicting unit becomes higher than said threshold level, said control unit selects the second mode.

16. The broadcast receiving terminal as claimed in claim 1, further comprising:
a program information storage unit for previously storing thereinto program information indicative of a content of a program;
a storage unit for storing thereinto a program sort list for setting said broadcast receiving terminal to any one of said first and second modes;
a program sort judging unit for judging a program sort under reception based upon said program information of the program information storage unit; and
a program sort comparing unit for performing a comparing operation for checking whether or not the program sort judged by said program sort judging unit is present in said program sort list; and wherein:
said control unit controls the switching unit so as to constitute the mode which is selected in response to a comparison result made by said program sort comparing unit.

17. The broadcast receiving terminal as claimed in claim 16 wherein:
when the program sort judged by said program sort judging unit is contained in said program sort list, the control unit selects the second mode, whereas when the program sort judged by said program sort judging unit is not contained in said program sort list, the control unit selects the first mode.

18. The broadcast receiving terminal as claimed in claim 1, further comprising:
a present position acquiring unit for acquiring a present position of said broadcast receiving terminal;
a storage unit for storing thereinto a positional range for setting said broadcast receiving terminal to any one of said first and second modes; and
a present position judging unit for comparing the present position acquired by said present position acquiring unit with said positional range so as to judge that the present position of the broadcast receiving terminal is located in the vicinity of said positional range; and wherein:
said control unit controls the switching unit so as to constitute the mode which is selected in response to a comparison result made by said present position judging unit.

19. The broadcast receiving terminal as claimed in claim 18 wherein:
when said broadcast receiving terminal is present within said position range, which is judged by said present position judging unit, said control unit selects the second mode.

20. The broadcast receiving terminal as claimed in claim 18 wherein:
when said broadcast receiving terminal is not present within said position range, which is judged by said present position judging unit, said control unit selects the first mode.

21. The broadcast receiving terminal as claimed in claim 1, further comprising:
a present position acquiring unit for acquiring a present position of said broadcast receiving terminal;
a present position history storage unit for storing thereinto the present positions acquired by said present position acquiring unit by being dated back to a constant time; and
a move judging unit for judging whether said broadcast receiving terminal is moved, or is stationary based upon a history as to the positional information of said broadcast receiving terminal obtained from said present position history storage unit; and wherein:
said control unit controls the switching unit so as to constitute the mode which is selected in response to a judgement result of said move judging unit.

22. The broadcast receiving terminal as claimed in claim 21 wherein:
when said move judging unit judges that said broadcast receiving terminal has not been stationary for a constant time, said control unit selects the second mode.

23. The broadcast receiving terminal as claimed in claim 21 wherein:
when said move judging unit judges that said broadcast receiving terminal has not been moved for a constant time, said control unit selects the first mode.

24. The broadcast receiving terminal as claimed in claim 1, further comprising:
a battery for supplying electric power to said broadcast receiving terminal; and
a battery under recharging operation judging unit for judging whether or not said battery is under recharging operation; and wherein:
said control unit controls the switching unit so as to constitute the mode which is selected in response to such a condition for indicating whether or not said battery is under the recharging operation.

25. The broadcast receiving terminal as claimed in claim 24 wherein:
when said battery under recharging operation judging unit judges that the battery is not under the recharging operation, said control unit selects the second mode, whereas when said battery under recharging operation judging unit judges that the battery is under the recharging operation, said control unit selects the first mode.

26. The broadcast receiving terminal as claimed in claim 1, further comprising:
a display unit for displaying thereon information in the form of any one of a character and a figure; and wherein:
in the case that said switching unit has switched the mode, said control unit performs a process operation in such a manner that said display unit displays thereon an indication for indicating that the mode has been switched.
